(19) United States
(12) Patent Application Publication
(10) Pub. No.: US 2017/0363348 A1
(43) Pub. Date: Dec. 21, 2017

(54) SYSTEM AND METHOD OF REFRIGERATOR CONTENT TRACKING

(71) Applicant: Philip Bogrash, Ashdod (IL)

(72) Inventor: Philip Bogrash, Ashdod (IL)

(21) Appl. No.: 15/437,167

(22) Filed: Feb. 20, 2017

Related U.S. Application Data
(60) Provisional application No. 62/297,813, filed on Feb. 20, 2016.

(51) Int. Cl. F25D 29/00; G06K 7/14; G06K 7/10; G06K 19/06

(52) U.S. Cl. CPC F25D 29/00; G06K 19/06009; G06K 7/1413; G06K 7/10712; F25D 2700/06; F25D 2500/06

(57) ABSTRACT

A system and a method for tracking items stored in a refrigerator which includes the identifying unit comprising a few known devices such as bar code reader or voice command processor for identifying the incoming and outgoing items also including an olfactory sensor. Said sensor in addition to identification is to be used also for assessing the items' degree of freshness for the purpose of determination of its actual expected maximum storage time—this determination will be made by the computer processor accessing the pertinent database(s) while using the digital smell signature for said access, when necessary. Said database will contain the storage data for opened or unpacked or cooked items for which the storage time data on the package is not applicable as well as possibly the items ingredients and the nutritional content. The items actual shelf storage location will be determined by means of the miniature motion detectors in combination with the optical scanners located in each shelf compartment or by means of making the shelves and the horizontal surfaces of compartments electrostatically charged and detecting the capacitative change. On the way in or out the item will be identified and the content of the appropriate section on display will be updated.

### RELATIONSHIP TO OTHER APPLICATIONS

The present patent application is related pursuant to the concept of the unity of an invention to U.S. provisional patent application 62/297,813 and claims benefit of the filing date of said provisional application.

### BACKGROUND OF THE INVENTION

### 1. Field of the Invention

This invention relates to systems and methods for tracking items stored in refrigerators or other types of storage containers.

### 2. Description of the Prior Art

There is a number of so-called smart refrigerators on the market, which use various techniques for entering the items being put into a refrigerator into its memory; for instance Samsung's “Smart Refrigerator” uses a touch-screen upon which a graphic icon corresponding to the type of food item is selected by the user and then, using the screen function of dragging and dropping, the item's icon is dropped into the section on the refrigerator's screen image corresponding to the section of the refrigerator where the item(s) is being put. Then the user is supposed to manually enter via a keyboard the purchase data and the storage expiration date. This is a cumbersome process that few users will consistently apply and therefore it is an inadequate approach. The patent PCT/KR2012/000335 describes the identification of items being put into the refrigerator by means of optical recognition in combination with the voice dialogue wherein the refrigerator issues a voice query to the user regarding the correctness of its item identification and the user is expected to confirm by a voice command such identification or to do the item identification by means of a voice instruction to the refrigerator. This patent further describes the determination of the item placement location in the refrigerator by means of detecting the weight change acting on the whole refrigerator and a weight change acting on an individual shelf—however with the usual uneven items distribution on a shelf and the possibility of items repositioning on the shelf or between shelves and sections, the correct item addition or removal detection by this method will require the placement of at least two or more weight sensors under each shelf/section and four weight sensors under the whole refrigerator. Thus the item addition or removal detection by this method will require a fairly large plurality of weight sensors adding to the refrigerator's complexity and cost. Furthermore this method can prove inaccurate is some items are added while others are simultaneously removed. Also the weight measurements' accuracy can be affected by the refrigerator's vibration especially when it's motor starts or stops and when some objects are placed on top of the refrigerator or are, as is common, magnetically affixed to its door or sides. Thus the process of item identification is fairly cumbersome with the user expected to be having tiresome dialogues with the refrigerator about each item being added, whereas the means of detection of the addition or removal of items are unjustifiably complex, costly and of questionable reliability. Another relevant patent is CN201220549936 which describes a system and method for detecting the items' degree of freshness or the onset of spoilage by means of analyzing the air passing through the smell sensors. While the quality of the available translation is poor, that patent evidently does not mention the identification of food items by smell or the prediction of their expected storage time based on their degree of freshness and the data found in a database for a given item at a given degree of freshness. it appears not to suggest the smell testing of individual items, but rather describes the smell testing of the air contained in a refrigerator, freezer or a plurality of them. Thus the functionality described in this patent is very limited.

### 3. Objects and Advantages

One object of the present invention is to make possible the identification of items loaded into the refrigerator and adding them to the stored list of content without manually entering the item name by means of using an olfactory sensor.

Another object is to use the olfactory sensor for the purpose of identifying the degree of freshness of the individual items and their likely period of storage prior to spoilage. Another object is to be able to use the olfactory sensor in attachment or otherwise operatively connected to a mobile device such as a cell/mobile phone or as a standalone portable or wearable device with the means of accepting from the olfactory sensor's the data for the identification purposes as well as the freshness data and for transferring to the refrigerators computer processor said data and/or displaying the results data.

Another object is to use the olfactory sensor for the purpose of identifying the beginning of spoilage of the individual items at an early stage or the presence of unhealthy or medically counter-indicated ingredients possibly prior to said items purchase.

Another object is to make available for the user the information for each stored item, whose packaging has been opened/unpackaged and/or which has been cooked since or just prior the time of purchase, regarding its estimated storage time at the temperature setting in the section of the refrigerator where the said item has been placed.

Another object is to register in the memory device associated with the refrigerator where each item is stored by means of detecting the motion or change of content in a refrigerators section when an item is placed there or is removed from there.

### 4. DESCRIPTION

First embodiment of this invention will have an identifying unit possibly mounted on the inside of the refrigerator door and likely including known devices for the object identification such as for example an optical scanning device for optical object recognition and/or barcode reading device and/or voice input processor for accepting spoken item identification. It will also include an olfactory sensor or an array of specialized olfactory sensors possibly equipped with a miniature fan for forced air intake.

Said olfactory sensors (hereinafter artificial nose) housing can be given the appearance of an animal or human nose, so that there is no mistaking its function, and may include a built in switch which could be activated either by pressing on artificial nose or by a voice command or a close range motion detection in its immediate vicinity. In a different embodiment of the present invention the identifying information will be loaded onto an electronic shopping receipt possibly together with the in store olfactory sensor's assessment of the items freshness status and the presence of ingredients which may be detrimental to a user based on his health profile. Also the user identity determination capability may be included in the identifying unit such as by means of accepting the voice input regarding that or for example by smell of user's hand. The identifying unit is operatively connected with the computer processor which is to interpret the input from the identifying unit. Said computer processor has access to a database either residing at the computer processor of a given refrigerator or connected to it via the internet or computer network (hereinafter smell database) where the items names and bar codes (if the same exist) corresponding to various smells and their combinations are kept, together with the information related to the storage time data for unpacked/opened/cooked items—possibly with said information available for different stages of freshness or the onset of spoilage. Also the computer processor may have access to a large existing product database where the information about each product is stored including its caloric and nutritional content including vitamins and minerals, the ingredients and various natural and artificial additives and preservatives, storage time or expiration date for unopened container. Optionally for various foods not likely to have storage information in the large product database such as those foods cooked at home according to a family or ethnic recipe not only the expected period of storage before the item becomes unsafe to consume would be kept at the smell database, but the other information such as the ingredients and additives would be kept there as well. Also optionally the computer processor will have access to the user(s) pertinent health profile information such as allergies, intolerance and other counter-indications. Said information can be made manually or by voice instructions enterable and kept in the computer processor's memory storage or retrieved from an online source or from a source within the local (home) network. The computer processor also keeps in said memory storage device the list of items contained in the refrigerator together with their location and it is also operatively connected to either a screen display and/or to a communication device to enable the transmission of said refrigerator content data and other pertinent retrieved information to other devices with the display and editing capability such as a computer or cell/mobile phone. Once the item has been identified it will be put into one of the sections of the refrigerator, said section will be identified by means such as a miniature motion detector installed in each such section likely in combination with an optical scanner for the purpose of detecting the item addition or removal from a given shelf or section.

Alternatively the shelves themselves or their surfaces and the horizontal surfaces of sections/compartments can be made electrostatically charged and the addition or removal of items will be detected by means of detecting the capacitative change possibly also in combination with an optical scanner comparing the shelf or section's appearance before and after any changes to detect the item's addition or removal and distinguish it from the items merely being moved on a shelf or in a section. These means of detection of items addition or removal will be connected to the computer processor for the purposes of updating the content list including the item location. It is possible that in the future it will be possible to obtain the necessary storage time data and the ingredients etc information utilizing just one database when the large existing product databases will have all the necessary information including the smell signature, storage times in opened or unpacked or cooked condition and the ingredients. Conversely with the development of large capacity inexpensive data storage devices such a large database could be kept locally at the given refrigerator or connected to it via a local computer network and updated periodically over the Internet. As presently the storage time data for unpacked/opened/cooked items is largely non-existent that data could be developed mostly experimentally. The database is to be updated for each food item by its assessed by smell degree of freshness and a temperature setting of the refrigerator (or the temperature of the pertinent compartment/section of it) and then it is updated again with the freshness data obtained by the artificial nose upon item removal. This way the pattern of progression of loss of freshness and the onset of spoilage of these food items will become known; the more precise predictions of the items' expected storage time prior to spoilage will be possible. As due to such factors as the degree of cleanliness and the presence of bacterial, fungal etc contamination within individual refrigerator the actual item storage time may differ from the established typical storage time, the machine learning algorithms in the software ran by the computer processor will learn to adjust the predicted storage time to the exact expectation for each food item for the specific refrigerator.

### 5. Sketches and Diagrams

Not Applicable

### 6. Operation

In operation, when an electronic shopping receipt containing all the items bought is available, it will be downloaded into the refrigerators computer processor together with their freshness information. A location of items being loaded in the fridge can be indicated by a voice command or by identification in combination with the above described detection means. When an individual new item is to be added, the item identifying unit is activated either by pressing on it thereby activating a switch or by passing the item in the vicinity of it so that the close range motion detector would activate the said unit or by a voice input. If the item has been fully identified such as by a barcode reading the artificial nose would still be activated as well, to assess the degree of its freshness. If the item has not been fully identified or not identified at all the artificial nose would take the smell sample for the identification purpose and for the purpose of assessing the items freshness or the onset of spoilage. This data containing the smell identifying information (hereinafter smell signature) and the freshness information will be passed on to the computer processor which will perform the identification of the item by means of accessing the smell database using the smell signature as at least a part of the search key for accessing the database. If the item is found then its name will be retrieved from the database and if the storage information is not present in that smell database entry, a large external database will be accessed by the computer processor for the purposes of obtaining the information pertaining to its storage time in opened condition/unpacked condition (when such data becomes available in these databases) and the list of ingredients will be checked for user defined undesirable/unhealthy ingredients and/or such undesirable/unhealthy ingredients will be defined by the users health profiles accessed externally or kept locally. Warnings possibly with the recommended special cooking instructions will be sent to either the refrigerator display screen an/or the portable devices such as cell/mobile phones. Likewise the present chemical residues and impurities as well as the undesirable products of bacterial activity and/or spoilage caused by other reasons will be identified by the artificial nose and if found in high enough doses the warnings will be also sent.

When the item is removed from the refrigerator first a section's motion detector or a capacitative change indicator will produce a signal to the computer processor and if subsequently the item is passed by the identification unit the item will be deleted from the stored items list and the artificial nose will check its status in terms of freshness/spoilage and if necessary a warning will be displayed possibly with special cooking instructions. Also the pertinent database will be updated with the freshness status information together with the related length of storage for the purpose of further perfecting the accuracy of storage period predictions. if the item is not passed by the identification unit and there was no voice command to delete, the system will treat that event as a temporary removal.

What claimed is:

1. A system for tracking the content of a refrigerator comprising an item identifying unit which includes at least one olfactory sensor for the purpose of identifying the added and removed items by smell and obtaining smell data characterizing items' degree of freshness, the item location identifying means for the purpose of displaying the updated content for every refrigerator partition upon an item addition or removal, the means of determining the items storage times based on their degree of freshness, computer processing unit operatively connected to the other components of the system of the present invention.

2. A system of claim 1 wherein location identifying means include at least one motion detector and at least one optical scanning unit.

3. A system of claim 1 wherein location identifying means include at least two electrostatically charged planar members between which food items are stored and a capacitative change indicator means operatively connected to said planar members.

4. A system of claim 1 wherein the means of determining the items storage times based on their degree of freshness comprise a database accessible by the search parameters based on the smell identifying data.

5. A method of refrigerator content tracking comprising the steps of;
Providing a refrigerator comprising an olfactory sensor operatively connected to the database accessible at least by the digital smell signature
Passing the storage items past the olfactory sensor upon being put into refrigerator or being removed from it
Olfactory sensor generating digital smell signature and transmitting it to the computer processing unit
Computer processing unit accessing the smell database and retrieving the storage information and other pertinent information, whereupon it is processed and displayed
Motion detectors in combination with optical scanners detecting content changes upon addition or removal of identified items at specific storage compartments and feeding that information to the computer processing unit for update of items storage information.
